(19) United States
(12) Patent Application Publication
(10) Pub. No.: US 2012/0086426 A1
(43) Pub. Date: Apr. 12, 2012

(54) SINGLE-INDUCTOR MULTIPLE-OUTPUT POWER SUPPLY WITH DEFAULT PATH

(75) Inventor: Eric Smith, San Jose, CA (US)

(73) Assignee: APPLE INC., Cupertino, CA (US)

(21) Appl. No.: 12/903,078

(22) Filed: Oct. 12, 2010

(51) Int. Cl. G05F 3/16

(52) U.S. Cl. 323/311

(57) ABSTRACT

The disclosed embodiments relate to a power supply for a portable electronic device. This power supply includes a power source, an inductor, a control circuit, and an input switch that couples the input terminal of the inductor to either the power source or a reference voltage. The power supply also includes a first output path that produces a first output voltage and a second output path that produces a second output voltage. The first output path includes a first diode coupled between the output terminal of the inductor and the first output voltage, and a first output capacitor coupled between the first output voltage and the reference voltage. The second output path includes a second diode and an output switch coupled between the output terminal and the second output voltage, and a second output capacitor coupled between the second output voltage and the reference voltage.

### BACKGROUND

1. Field

The present embodiments relate to power supplies for electronic devices. More specifically, the present embodiments relate to a single-inductor multiple-output power supply with a default path.

2. Related Art

A switched-mode power supply in an electronic device generates an output voltage by charging and discharging an inductor using a switched input voltage. The output voltage may then be discharged into a capacitor to drive a load connected to the power supply. Because energy is stored in the inductor and/or capacitor, the switched-mode power supply is generally more efficient than a linear power supply that dissipates excess power in the form of heat.

However, switched-mode power supplies have a number of drawbacks, particularly when used in smaller portable electronic devices such as tablet computers, mobile phones, personal digital assistants (PDAs), and/or portable media players. First, switched-mode power supplies typically include inductors that are relatively large and expensive compared to other components in the power supplies. Furthermore, the inductors may be subject to a tradeoff between size and efficiency, in which inductors that are larger and/or more expensive are more efficient than smaller inductors. This tradeoff may interfere with the design of a portable electronic device that needs to be both small and power-efficient.

Second, multiple inductors are typically used to generate multiple output voltages in a switched-mode power supply. For example, a power supply with a +12V output, a 5V output, and a 3.3V output may include four inductors and eight switches. As a result, the size, cost, and/or power consumption of a power supply may increase with the number of output voltages generated by the power supply.

Hence, the use of portable electronic devices may be facilitated by improving the size, efficiency, and/or cost of power supplies for the portable electronic devices.

### SUMMARY

The disclosed embodiments relate to a power supply for a portable electronic device. This power supply includes a power source, an inductor, a control circuit, and an input switch that couples the input terminal of the inductor to either the power source or a reference voltage. The power supply also includes a first output path that produces a first output voltage and a second output path that produces a second output voltage. The first output path includes a first diode coupled between the output terminal of the inductor and the first output voltage, and a first output capacitor coupled between the first output voltage and the reference voltage. The second output path includes a second diode and an output switch coupled between the output terminal and the second output voltage, and a second output capacitor coupled between the second output voltage and the reference voltage.

In some embodiments, the control circuit generates the first output voltage and the second output voltage by controlling the input switch and the output switch. First, the control circuit modulates a duty cycle of the input switch to produce a charge phase and a discharge phase in the inductor, in which the charge phase occurs while the input switch couples the input terminal to the power source and the discharge phase occurs while the input switch couples the input terminal to the reference voltage.

Next, during the discharge phase of the inductor, the control circuit uses the output switch to couple the output terminal of the inductor to the first output path or the second output path. To generate the first output voltage, the control circuit opens the output switch during a first portion of the discharge phase to transfer current from the inductor to the first output path. To generate the second output voltage, the control circuit closes the output switch during a second portion of the discharge phase to transfer current from the inductor to the second output path and to stop the transfer of current from the inductor to the first output path.

In some embodiments, the first output voltage is greater than the second output voltage by a forward voltage drop of the first diode.

In some embodiments, the first output path corresponds to a default path for the power supply.

In some embodiments, the control circuit comprises an analog circuit.

In some embodiments, the power source includes a battery in the portable electronic device.

### BRIEF DESCRIPTION OF THE FIGURES

FIG. 1 shows a power supply for an electronic device in accordance with an embodiment.

FIG. 2 shows a system for generating multiple output voltages from an input voltage in accordance with an embodiment.

FIG. 3 shows a flowchart illustrating the process of supplying power to components in a portable electronic device in accordance with an embodiment.

FIG. 4 shows a portable electronic device in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

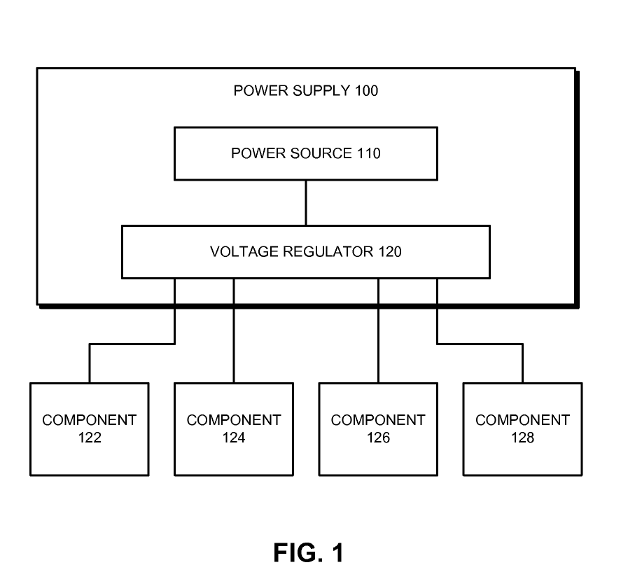

The disclosed embodiments provide a power supply for an electronic device. As shown in FIG. 1, the power supply 100 includes a power source 110 and a voltage regulator 120. Voltage regulator 120 may obtain an input voltage from power source 110 and convert the input voltage into a number of output voltages for use by components 122-128 in the electronic device. For example, voltage regulator 120 may provide a +12V output, a 5V output, and a 3.3V output to respectively power a hard disk drive, a serial port, a motherboard, and a central processing unit (CPU) in a computer system.

In one or more embodiments, power supply 100 supplies power to components (e.g., components 122-128) in a portable electronic device such as a laptop computer, tablet computer, mobile phone, personal digital assistant (PDA), portable media player, and/or digital camera. Consequently, power source 110 may include a battery or battery pack in the portable electronic device, such as a lithium-ion and/or lithium-polymer battery pack.

Furthermore, power supply 100 may be designed to accommodate size and/or power constraints associated with the portable electronic device. In particular, the powering of the portable electronic device from a battery may require a level of power efficiency in the portable electronic device, while the form factor of the portable electronic device may restrict the use of larger and/or heavier components in the portable electronic device. As a result, power supply 100 may be a switched-mode power supply that converts voltage from power source 110 using inductors and/or capacitors, instead of a larger, heavier, and/or more inefficient linear regulated power supply that dissipates excess voltage as heat.

However, switched-mode power supplies may also consume significant amounts of power and/or space in portable electronic devices. For example, a voltage regulator for a CPU may operate at 60-70% efficiency and take up roughly the same amount of space as the CPU. Voltage regulation in a switched-mode power supply may additionally involve a tradeoff between size and efficiency, in which a larger inductor can generate a given output voltage at a lower switching frequency, and thus dissipate less power, than a smaller inductor. Power and/or space consumption may further increase if each output voltage of power supply 100 requires the use of a separate inductor and/or one or more switches.

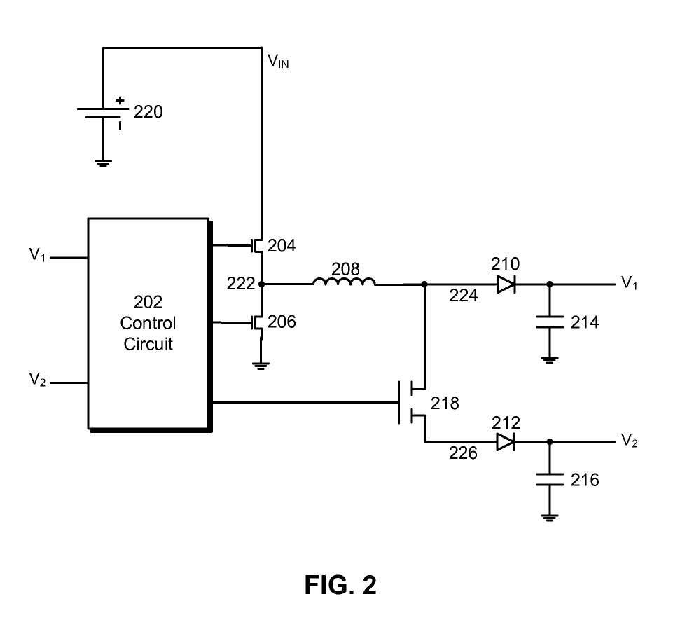

In one or more embodiments, power supply 100 corresponds to a single-input, multiple-output (SIMO) power supply with a default path. As discussed in further detail below with respect to FIG. 2, the SIMO power supply may reduce the number of inductors and/or switches required to generate multiple output voltages in the portable electronic device. Consequently, power supply 100 may represent an improvement in size, cost, safety, and/or power consumption over other power supply topologies.

FIG. 2 shows a system for generating multiple voltages from an input voltage in accordance with an embodiment. More specifically, FIG. 2 shows a circuit for generating a first output voltage (e.g., “V₁”) and a second output voltage (e.g., “V₂”) from an input voltage (e.g., “V_{IN}”). As shown in FIG. 2, the input voltage is supplied from a power source 220, such as a battery for a portable electronic device. In addition, the input voltage is converted into the first and second output voltages using a control circuit 202, two field-effect transistors (FETs) 204-206, an inductor 208, two diodes 210-212, two capacitors 214-216, and a switch 218. Consequently, the circuit of FIG. 2 may provide a SIMO power supply with one input voltage and two output voltages.

First, control circuit 202 may periodically charge and discharge inductor 208 by coupling the input terminal of inductor 208 to either power source 220 or a reference voltage (e.g., ground). Control circuit 202 may cause inductor 208 to enter a charge phase by closing a control FET 204 and opening a synchronous FET 206. During the charge phase, the input terminal of inductor 208 is coupled to power source 220, and a positive voltage drop develops across inductor 208 as inductor current increases.

Conversely, control circuit 202 may cause inductor 208 to enter a discharge phase by opening control FET 204 and closing synchronous FET 206. During the discharge phase, the input terminal of inductor 208 is coupled to the reference voltage, a negative voltage drop develops across inductor 208 as current stored in inductor 208 discharges, and a return path for the discharging inductor 208 is provided by synchronous FET 206. As a result, FETs 204-206 may provide an input switch that switches the input voltage supplied to the input terminal of inductor 208 at a switch node 222 of the circuit.

Next, control circuit 202 may open and close an output switch 218 as inductor 208 discharges (e.g., with FET 204 open and FET 206 closed). Output switch 218 may correspond to a FET and/or other active switching component. To generate the first output voltage, control circuit 202 may open output switch 218 during a first portion of the discharge phase of inductor 208. With output switch 218 open, current from inductor 208 flows through diode 210, and the first output voltage is produced along a first output path 224 containing diode 210 and capacitor 214. In addition, capacitor 214 may collect current discharging from inductor 208, supply the current to a load connected to path 224, and act as a low-pass filter by reducing voltage ripple caused by fluctuating current through inductor 208.

Control circuit 202 may then generate the second output voltage by closing output switch 218 during a second portion of the discharge phase of inductor 208. With output switched 218 closed, current from inductor 208 flows through diode 212, and the second output voltage is produced along a second output path 226 containing diode 212 and capacitor 216. As with capacitor 214 in path 224, capacitor 216 may collect current from inductor 208 to supply a constant second output voltage to a load connected to path 226.

Furthermore, diodes 210-212 and/or paths 224-226 may be configured so that the closing of output switch 218 causes current from inductor 208 to stop flowing to path 224 and start flowing through path 226. For example, diode 212 may be a Schottky diode with a slightly lower forward voltage drop than diode 210. As a result, the closing of output switch 218 may cause diode 212 to conduct increasing amounts of current until the voltage across diode 210 falls below the forward voltage drop of diode 210 and diode 210 stops conducting current to path 224. Diodes 210-212 may additionally cause path 226 to produce a second output voltage that is lower than the first output voltage by the forward voltage drop of diode 210.

In one or more embodiments, the absence of a switch in path 224 allows path 224 to act as a default path for current from inductor 208. The default path may protect components in the circuit by preventing open circuits that trigger high-energy discharges from inductor 208. The default path may additionally simplify the design of control circuit 202 by allowing control circuit 202 to drive inductor 208 in continuous mode.

The first and second output voltages may then be fed back to control circuit 202 to facilitate the continued generation of appropriate output voltages from the input voltage. First, control circuit 202 may modulate the duty cycle of the input switch (e.g., FETs 204-206) to control the total amount of power supplied to both paths 224-226 (e.g., based on load state and/or input voltage). Control circuit 202 may increase the duty cycle of the input switch to increase the total power outputted by the power supply, or control circuit 202 may decrease the duty cycle of the input switch to decrease the total power outputted by the power supply.

Next, control circuit 202 may divide the total output power between the first and second output paths by modulating the duty cycle of output switch 218 during the discharge phase of inductor 208 (e.g., when the input switch couples inductor 208 to the reference voltage). To increase the first output power and decrease the second output power, control circuit 202 may reduce the duty cycle of output switch 218 to keep output switch 218 open for longer periods. On the other hand, control circuit 202 may increase the duty cycle of output switch 218 to close output switch 218 for longer periods and increase the second output power relative to the first output power.

Those skilled in the art will appreciate that the circuit of FIG. 2 may be implemented in a variety of ways. For example, components in the circuit may be provided by an application-specific integrated circuit (ASIC), with the exception of power source 220. Alternatively, the circuit may utilize other combinations of integrated and discrete components. Along the same lines, control circuit 202 may be implemented as an analog and/or digital circuit based on design requirements associated with the size, operating voltage, power density, transient response, and/or light-load efficiency of the power supply.

By generating two output voltages using a single inductor, three FETs, and two diodes, the power supply may be cheaper, smaller, more efficient, less complex, and/or safer than other power supply topologies. In particular, the power supply may improve on the efficiency, cost, and/or size of single-input, single-output power supplies by using only half the number of inductors to produce the same number of output voltages.

The power supply may also be more efficient and/or simpler to implement than other SIMO power supplies. For example, the use of diode 210 on path 224 may allow the light-load efficiency of the power supply to be better than that of a SIMO power supply that actively switches between two output paths using a FET on each output path. Similarly, the existence of a default path 224 may enable the operation of the power supply in continuous mode, simplify the design of control circuit 202, and/or prevent damage that may otherwise occur in SIMO power supplies without default paths. Finally, the generation of both output voltages during a single switching cycle (e.g., charge phase followed by discharge phase) of inductor 208 may provide a better transient response than a power supply that generates only one output voltage per switching cycle.

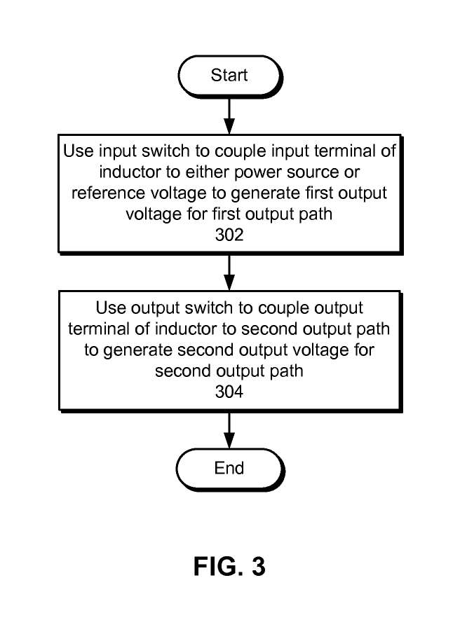

FIG. 3 shows a flowchart illustrating the process of supplying power to components in a portable electronic device in accordance with an embodiment. In one or more embodiments, one or more of the steps may be omitted, repeated, and/or performed in a different order. Accordingly, the specific arrangement of steps shown in FIG. 3 should not be construed as limiting the scope of the embodiments.

First, an input switch is used to couple the input terminal of an inductor to either a power source or a reference voltage to generate a first output voltage for a first output path (operation 302). The first output path may include a first diode coupled between the output terminal of the inductor and the first output voltage, and a first output capacitor coupled between the first output voltage and the reference voltage.

In particular, the input switch may charge the inductor by coupling the inductor to the power source, and then discharge the inductor by coupling the inductor to the reference voltage. In addition, the first output path may correspond to a default path for a power supply in the portable electronic device. As a result, the first output voltage may be produced by current that discharges from the inductor into the first output path in the absence of an alternative return path for the inductor.

Next, an output switch is used to couple the output terminal of the inductor to a second output path to generate a second output voltage for the second output path (operation 304). The second output path may include a second diode and the output switch coupled between the output terminal and the second output voltage, as well as a second output capacitor coupled between the second output voltage and the reference voltage.

Because current flow through the second diode may cause the first diode to stop conducting, the coupling of the second output path to the output terminal may effectively disconnect the first output path from the inductor. As a result, the second output voltage may be generated by diverting current from the discharging inductor into the second output path instead of allowing all of the discharged current to flow into the first, default output path. Furthermore, the presence of diodes on both output paths may cause the first output voltage to be greater than the second output voltage by a forward voltage drop of the first diode.

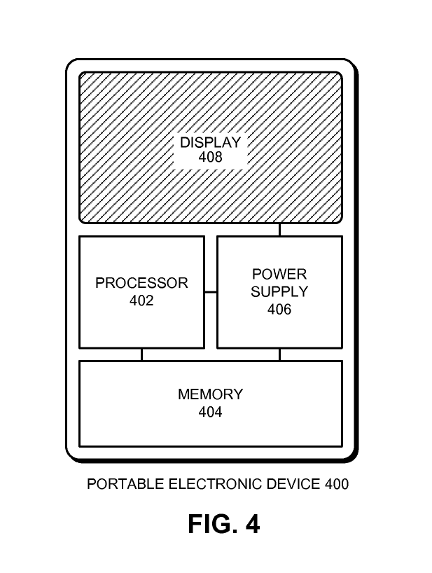

The above-described rechargeable battery cell can generally be used in any type of electronic device. For example, FIG. 4 illustrates a portable electronic device 400 which includes a processor 402, a memory 404 and a display 408, which are all powered by a power supply 406. Portable electronic device 400 may correspond to a laptop computer, tablet computer, mobile phone, PDA, portable media player, digital camera, and/or other type of battery-powered electronic device. Power supply 406 may include a power source such as a battery pack that includes one or more battery cells. Power supply 406 may also include a control circuit that generates a first output voltage and a second output voltage from an input voltage of the power source.

First, the control circuit may modulate a duty cycle of an input switch that couples the input terminal of an inductor to either the power source or a reference voltage. The control circuit may thus produce a charge phase and a discharge phase in the inductor, in which the charge phase occurs while the input switch couples the input terminal to the power source and the discharge phase occurs while the input switch couples the input terminal to the reference voltage.

Next, during the discharge phase of the inductor, the control circuit may couple the output terminal of the inductor to a first output path or a second output path. The first output path may include a first diode coupled between the output terminal and the first output voltage, and a first output capacitor coupled between the first output voltage and the reference voltage. The second output path may include a second diode and an output switch coupled between the output terminal and the second output voltage, as well as a second output capacitor coupled between the second output voltage and the reference voltage.

To generate the first output voltage, the control circuit may open the output switch during a first portion of the discharge phase to transfer current from the inductor to the first output path. To generate the second output voltage, the control circuit may close the output switch during a second portion of the discharge phase to transfer current from the inductor to the second output path and to stop the transfer of current from the inductor to the first output path.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A power supply, comprising:
a power source;
an inductor with an input terminal and an output terminal;
an input switch configured to couple the input terminal of the inductor to either the power source or a reference voltage;
a first output path configured to produce a first output voltage, comprising:
a first diode coupled between the output terminal and the first output voltage; and
a first output capacitor coupled between the first output voltage and the reference voltage;
a second output path configured to produce a second output voltage, comprising:
a second diode and an output switch coupled between the output terminal and the second output voltage; and
a second output capacitor coupled between the second output voltage and the reference voltage; and
a control circuit configured to control the input switch and the output switch to generate the first output voltage and the second output voltage.

2. The power supply of claim 1,
wherein the control circuit generates the first output voltage by opening the output switch during a first portion of a discharge phase of the inductor, and
wherein the control circuit generates the second output voltage by closing the output switch during a second portion of the discharge phase.

3. The power supply of claim 2, wherein the control circuit further generates the first output voltage and the second output voltage by modulating a duty cycle of the input switch.

4. The power supply of claim 1, wherein the first output voltage is greater than the second output voltage by a forward voltage drop of the first diode.

5. The power supply of claim 1, wherein the first output path corresponds to a default path for the power supply.

6. The power supply of claim 1, wherein the control circuit comprises an analog circuit.

7. The power supply of claim 1, wherein the power source comprises a battery.

8. A method for supplying power to components in a portable electronic device, comprising:
using an input switch to couple an input terminal of an inductor to either a power source or a reference voltage to generate a first output voltage for a first output path, wherein the first output path comprises:
a first diode coupled between an output terminal of the inductor and the first output voltage; and
a first output capacitor coupled between the first output voltage and the reference voltage; and
using an output switch to couple the output terminal of the inductor to a second output path to generate a second output voltage for the second output path, wherein the second output path comprises:
a second diode and the output switch coupled between the output terminal and the second output voltage; and
a second output capacitor coupled between the second output voltage and the reference voltage.

9. The method of claim 8,
wherein the first output voltage is generated by opening the output switch during a first portion of a discharge phase of the inductor, and
wherein the second output voltage is generated by closing the output switch during a second portion of the discharge phase.

10. The method of claim 9, wherein the first output voltage and the second output voltage are further generated by modulating a duty cycle of the input switch.

11. The method of claim 8, wherein the first output voltage is greater than the second output voltage by a forward voltage drop of the first diode.

12. The method of claim 8, wherein the first output path corresponds to a default path for a power supply in the portable electronic device.

13. The method of claim 8, wherein the power source comprises a battery in the portable electronic device.

14. A portable electronic device, comprising:
a set of components; and
a power supply configured to supply power to the components, wherein the power supply comprises:
a power source;
an inductor with an input terminal and an output terminal;
an input switch configured to couple the input terminal of the inductor to either the power source or a reference voltage;
a first output path configured to obtain a first output voltage, comprising:
a first diode coupled between the output terminal and the first output voltage; and
a first output capacitor coupled between the first output voltage and the reference voltage;
a second output path configured to obtain a second output voltage, comprising:
a second diode and an output switch coupled between the output terminal and the second output voltage; and
a second output capacitor coupled between the second output voltage and the reference voltage; and
a control circuit configured to control the input switch and the output switch to generate the first output voltage and the second output voltage.

15. The portable electronic device of claim 14,
wherein the control circuit generates the first output voltage by opening the output switch during a first portion of a discharge phase of the inductor, and
wherein the control circuit generates the second output voltage by closing the output switch during a second portion of the discharge phase.

16. The portable electronic device of claim 15, wherein the control circuit further generates the first output voltage and the second output voltage by modulating a duty cycle of the input switch.

17. The portable electronic device of claim 14, wherein the first output voltage is greater than the second output voltage by a forward voltage drop of the first diode.

18. The portable electronic device of claim 14, wherein the first output path corresponds to a default path for the power supply.

19. The portable electronic device of claim 14, wherein the control circuit comprises an analog circuit.

20. The portable electronic device of claim 14, wherein the power source comprises a battery.
